(19) United States
(12) Patent Application Publication
(10) Pub. No.: US 2025/0379380 A1
(43) Pub. Date: Dec. 11, 2025

(54) COMPACT HIGH SPEED NEAR CHIP CONNECTOR

(71) Applicant: FCI USA LLC, Etters, PA (US)

(72) Inventors: Arkady Y. Zerebilov, Lancaster, PA (US); Michael Rowlands, Milford, MA (US); Vasanth Paul Jayaseelan, Markham (CA)

(73) Assignee: FCI USA LLC, Etters, PA (US)

(21) Appl. No.: 19/301,373

(22) Filed: Aug. 15, 2025

Related U.S. Application Data
(63) Continuation of application No. 19/052,669, filed on Feb. 13, 2025.
(60) Provisional application No. 63/553,119, filed on Feb. 13, 2024.

(51) Int. Cl. H01R 12/71; H01R 12/72; H01R 13/02; H01R 13/58; H01R 13/627; H01R 13/639; H01R 13/6471; H01R 13/6587

(52) U.S. Cl. CPC H01R 12/716; H01R 12/724; H01R 13/02; H01R 13/582; H01R 13/6271; H01R 13/6471; H01R 13/639; H01R 13/6587

(57) ABSTRACT

A compact, pressure mount connector suitable for use as a near chip connector with one or more features to facilitate signal integrity at high frequency or density. The connector may be formed of contact subassemblies that are held in a retainer. Bump outs may be attached to side walls of the retainer to introduce a side-to-side stagger of the subassemblies. Each subassembly may include a shield bounding regions in which cables are terminated. The shield may have projections shaped to be electrically coupled to one another and to mating contact portions of ground beams. Conductive elements of the subassemblies may have bytes on edges of their mating contact regions to facilitate mating to a substrate. The retainer may be mounted in a housing that fits within a fence mounted to a substrate. A cover engaging the fence may provide mating force.

### CROSS-REFERENCE TO RELATED APPLICATIONS

This application is a continuation of U.S. patent application Ser. No. 19/052,669, filed on Feb. 13, 2025, entitled “COMPACT HIGH SPEED NEAR CHIP CONNECTOR,” which claims priority to and the benefit under 35 U.S.C. § 119(e) of U.S. Provisional Patent Application Ser. No. 63/553,119, filed on Feb. 13, 2024, entitled “COMPACT HIGH SPEED NEAR CHIP CONNECTOR.” The contents of these applications are incorporated herein by reference in their entirety.

### BACKGROUND

This disclosure relates generally to an electrical connector and, more specifically, to a compact high speed near chip connector.

Electrical connectors are used in many electronic systems. It is generally easier and more cost effective to manufacture a system as separate electronic subassemblies, such as printed circuit boards (PCBs) or chip packages, which may be joined together with electrical connectors. Having separable connectors enables components of the electronic system manufactured by different manufacturers to be readily assembled. Separable connectors also enable components to be readily replaced after the system is assembled, either to replace defective components or to upgrade the system with higher performance components.

Subassemblies may be joined with two-piece connectors, with one connector piece on each subassembly to be joined. In a known arrangement of this type, one subassembly may serve as a backplane. Other printed circuit boards, called “daughterboards” or “daughtercards,” may be connected through the backplane. The backplane may include many connectors that are electrically connected through the backplane. In some systems, a backplane is implemented as a printed circuit board and the connectors are connected through conducting traces in the printed circuit board. In other systems, the backplane may be implemented with cables making electrical connections among the connectors of the backplane. Daughtercards may also have connectors mounted thereon. The connectors mounted on a daughtercard may be plugged into the connectors mounted on the backplane. In this way, signals may be routed among the daughtercards through the backplane. The daughtercards may plug into the backplane at a right angle. The connectors on the daughtercards may therefore include a right angle bend and are often called “right angle connectors.”

Connectors may also be used in other configurations for interconnecting subassemblies. Sometimes, one or more smaller printed circuit boards may be connected to another larger printed circuit board. In such a configuration, the larger printed circuit board may be called a “motherboard” and the printed circuit boards connected to it may be called daughterboards. If the boards to be connected are aligned in parallel, the boards may be connected through connectors often called “stacking connectors” or “mezzanine connectors.” In other architectures, the motherboard may include a card edge connector and an edge of the daughtercard may be inserted into the card edge connector, making connections between the daughter card and the mother board.

Connectors may also be used to enable signals to be routed to or from an electronic device. A connector, called an “I/O connector,” may be mounted to a printed circuit board, usually at an edge of the printed circuit board. That connector may be configured to receive a plug at one end of a connector assembly, such that the cable is connected to the printed circuit board through the I/O connector. The other end of the connector assembly may be connected to another electronic device.

Cables have also been used to make connections within the same electronic device. The cables may be used to route signals from an I/O connector to a processor assembly or other high performance chips that is are located at the interior of a printed circuit board, away from the edge at which the I/O connector is mounted. In other configurations, both ends of a cable may be connected to the same printed circuit board. The cables can be used to carry signals between components mounted to the printed circuit board near where each end of the cable connects to the printed circuit board. In yet other system configurations, cables may be used to route signals between connectors that mate with daughterboards to the vicinity of a high performance chip, which may be near the interior of a printed circuit board, whether the same or a different printed circuit board to which the connector is mounted.

Routing signals through a cable, rather than through a printed circuit board, may be advantageous because the cables provide signal paths with high signal integrity, particularly for high frequency signals, such as those above 40 Gbps using an NRZ protocol or higher bit rates, such as 56 Gbps or higher, using higher order modulation, such as PAM 4. Known cables have one or more signal conductors, which is surrounded by a dielectric material, which in turn is surrounded by a conductive layer. A protective jacket, often made of plastic, may surround these components. Additionally, the jacket or other portions of the cable may include fibers or other structures for mechanical support.

One type of cable, referred to as a “twinax cable,” is constructed to support transmission of a differential signal and has a balanced pair of signal wires embedded in a dielectric and encircled by a conductive layer. The conductive layer is usually formed using foil, such as aluminized Mylar. The twinax cable can also have a drain wire. Unlike a signal wire, which is generally surrounded by a dielectric, the drain wire may be uncoated so that it contacts the conductive layer at multiple points over the length of the cable. At an end of the cable, where the cable is to be terminated to a connector or other terminating structure, the protective jacket, dielectric and the foil may be removed, leaving portions of the signal wires and the drain wire exposed at the end of the cable. These wires may be attached to a terminating structure, such as a connector. The signal wires may be attached to conductive elements serving as mating contacts in the connector structure. The foil may be attached to a ground conductor in the terminating structure, either directly or through the drain wire, if present. In this way, any ground return path may be continued from the cable to the terminating structure.

High speed, high bandwidth cables and connectors have been used to route signals to or from processors and other electrical components that process a large number of high speed, high bandwidth signals. These cables and connectors reduce the attenuation of the signals passing to or from these components relative to what might occur were the same signals routed over a similar distance through a printed circuit board. This benefit may be most pronounced at high frequencies, such as the frequencies required to support 112 Gbps or higher data rates.

To integrate such cables into an electronic system, they may be formed into cable assemblies. Within a cable assembly, one end of the cables may be terminated to a connector, such as an I/O connector or a backplane-style connector that mates with daughterboards. The other end of the cables may be terminated to a connector, sometimes called a near chip connector, that makes connections to a printed circuit board, either directly or through mating with another connector. Direct connections may be formed with a pressure mount connector in which the mating contacts press against conductive pads on a circuit of a PCB, making separable connections when the connector is pressed against the PCB.

Despite the benefits of transmitting high speed signals through cables rather than a printed circuit board, using a cable assembly may provide little or no benefit if the near-chip connector of the cable assembly does not support the frequencies of the signals transmitted through the cables. A near chip connector necessarily entails a discontinuity between the cables and a printed circuit board. Such a discontinuity can interfere with the integrity of signals passing through the cable assembly, particularly at higher frequencies, and may limit the operating frequency of the cable assembly and therefore of the electronic system.

### SUMMARY

According to an aspect of the present disclosure, a contact subassembly for an electrical connector includes a first plurality of contact beams at a first side of the contact subassembly, a conductive network interconnecting the first plurality of contact beams, and a second plurality of contact beams interspersed with the first plurality of contact beams, each of the second plurality of contact beams comprising a portion of a contact of a plurality of contacts. A corrugated member includes a body including valleys electrically and mechanically connected to the conductive network, portions between the valleys, each of the portions aligned with and electrically separate from the portion of at least one contact of the plurality of contacts, and a plurality of projections extending from the body at the first side. Each of the plurality of projections is electrically connected to a contact beam of the first plurality of contact beams, and includes a first portion integral with the body and a second portion extending in a direction transverse to the first portion. Second portions of adjacent projections of the plurality of projections are electrically connected to each other.

According to another aspect of the present disclosure, an electrical connector includes a holder comprising a first side wall and a second side wall; a plurality of wafers mounted in parallel between the first side wall and the second side wall, and a plurality of members to engage a wafer. Each of the plurality of bump outs is attached to the first side wall or the second side wall, and each of the bump outs is between a respective wafer of the plurality of wafers and a respective sidewall of the first side or the second side wall in a staggered fashion such that each wafer of the plurality of wafers engages a side wall of the first or second side walls and a bump out of the plurality of bump outs.

According to another aspect of the present disclosure, a pressure mount connector with a mating face includes a plurality of signal contacts, each of the plurality of signal contacts comprising a mating contact portion comprising a beam extending in a length direction to a distal end. The distal ends of the plurality of signal contacts are disposed in a planar array at a mating face of the pressure mount connector. The distal end of each of the plurality of signal contacts comprises a convex surface extending in a width direction perpendicular to the length direction from a first edge to a second edge. At least one of the first edge and the second edge includes a projection extending from the convex surface.

The foregoing features may be used, separately or together in any combination in any of the foregoing embodiments.

### BRIEF DESCRIPTION OF DRAWINGS

The accompanying drawings are not necessarily drawn to scale. For the purposes of clarity, not every component may be labeled in every drawing. In the drawings:

FIG. 1A is a top perspective view of a connector;

FIG. 1B is a bottom perspective view of the connector 100 of FIG. 1A with the cover removed;

FIG. 1C is a bottom view of the connector of FIG. 1A;

FIG. 2 is a partially exploded view of a connector;

FIG. 3 is a top perspective view of a connector with a clamp plate separated from a strain relief structure;

FIG. 4 is a perspective view of a connector with an expanded view of the interface between the strain relief structure and housing;

FIG. 5 is an exploded view of aspects of a connector;

FIG. 6 is an exploded view of aspects of a connector showing a wafer assembly separated from the housing;

FIG. 7A is a perspective view of a wafer retainer showing bump outs on a side wall surface;

FIG. 7B shows one of the bump outs, implemented as a spacer, separated from the side wall surface;

FIG. 7C shows a perspective view of the wafer retainer showing bump outs on an opposite side wall surface to the one shown in FIG. 7A;

FIG. 7D is a top-down view of the wafer retainer showing the bump outs on opposite side walls;

FIG. 8 is a perspective view of connector revealing wafers when mated to a substrate;

FIG. 9 is a perspective view of multiple wafers, positioned as they might be held within an exemplary wafer assembly;

FIG. 10 shows an enlarged view of a portion of a wafer showing contact tips with projections;

FIG. 11 details aspects of a shorting bar of an exemplary wafer;

FIG. 12 is a bottom perspective view of a wafer;

FIG. 13A shows an exploded view of aspects of a wafer with the stiffener separated;

FIG. 13B shows the exploded view of FIG. 13A from a different perspective;

FIG. 14A shows an exploded view of aspects of a wafer with the wave shield separated and a first edge visible;

FIG. 14B shows the exploded view of FIG. 14A from a side;

FIG. 14C shows the exploded view of FIG. 14A with a second edge visible;

FIG. 15 is a perspective view of the metal member of a wafer;

FIG. 16 is a perspective view of the metal member of a wafer with insulative material omitted;

FIG. 17A shows a fence of a connector prior to engagement with a pick and place cap; and

FIG. 17B shows the fence of the connector engaged with the pick and place cap.

### DETAILED DESCRIPTION

The inventors have recognized and appreciated designs for cable near chip connectors that support very high frequencies of operation, including frequencies above 112 Gbps, and up to and beyond 224 Gbps, while meeting prevailing metrics of signal integrity. For example, the connector may provide −1 dB loss to 28 GHz; −12 dB reflections to at least 28 GHz (such as up to 40 GHz); and power sum crosstalk of less than −55 dB near-end crosstalk (NEXT), such as −60 dB (NEXT) and less than −35 dB far-end crosstalk (FEXT), such as −40 dB (FEXT). Such connectors may also support a high density of interconnects. Signal contacts associated with pairs of signals may be separated center-to-center by less than 1.0 mm, such as with a 0.6 mm contact pitch maintained in pair or other contact pitch in the range of 0.4 to 0.8 mm.

Pairs of signal conductors within a row may be separated by less than 3.5 mm center-to-center, such as with a pitch of 3.2 mm or other pitch in the range of 3.0 mm to 3.5 mm. The rows may also be separated by less than 3.5 mm, center-to-center, such as with a row pitch between 2.0 and 3.0 mm, such as 2.5 mm or other row pitch in the range of 2.7 to 3.3 mm. A connector with this density may, for example, support a connection density of 16 differential pairs per connector in an area on a printed circuit board to which the connector is mated (e.g. the connector footprint) smaller than 250 square millimeters, or less than 15.5 square millimeters, in some examples, such as approximately 230 square millimeters.

Connectors as described herein may enable efficient manufacture of small, high performance electronic devices, such as servers and switches. These near chip connectors support a high density of high-speed signal connections to processors and other components in the mid-board (i.e. daughterboard) region of the electronic device. The other ends of cables terminated to the connector may be connected to a connector, such as an I/O or backplane-style connector, or at another location remote from the midboard such that the cables of a connector assembly may carry high-speed signals, with high signal integrity, over long distances, such as 6 inches or more.

The connector may support a pressure mount interface to a substrate (e.g., a printed circuit board (PCB) or semiconductor chip substrate) carrying a processor or other components processing a large number of high speed signals. The connector may incorporate features that provide a large number of pressure mount interconnection points in a relatively small volume. Each set of interconnection points may be associated with one wafer. The connector may include a set of wafers manufactured in a similar way, with the interconnection points among the different wafers being parallel but in different planes. The connector height may be on the order of 12 millimeters or less.

The connector may terminate multiple cables with a contact tip respectively connecting to each signal conductor in each cable and one or more contact tips coupled to a grounding structure within the cables. For drainless twinax cable, for example, the connector may have, for each cable, two contact tips electrically coupled to the cable signal conductors and either one or two contact tips coupled to a shield around the cable signal conductors. For each cable, the two contact tips coupled to the cable signal conductors may be separated by a center-to-center distance of 0.6 millimeters or less. The contact tips may, for example, be beams extending outwards along an edge of the wafer such that they are positioned to contact complementary pads on a mating structure, such as a printed circuit board. The wafers may be aligned within the connector such that the contact tips from multiple wafers are in parallel planes, which may define the mating interface of the connector.

In some examples, mating surfaces of the signal contact beams and/or ground contact beams may be shaped for making reliable contact despite generating a relatively small amount of force. The mating portions, for example, may have a convex contact surface, which may be plated. Edges of the contact surface may protrude toward the mating pad from the contact surface such that the extending edges will preferentially make contact with a mating pad. Such protruding portions may decrease the contact area such that, even with a relatively small normal force (e.g., 40 grams), there will be a relatively large pressure at the contact area. The contact width may be on the order of 0.04 to 0.12 millimeters. A large pressure may pierce oxides or other contaminants on the contacts, leading to more reliable connections. Such areas may be formed by coining the edges of the contact beams, and may form structures illustrated in the drawings as bite marks.

According to exemplary embodiments described herein, any suitably sized cable conductors may be employed and coupled to a suitably sized contact tip. In some embodiments, cable conductors may have a diameter less than or equal to 32 AWG. In other embodiments, cable conductors may have a diameter less than or equal to 27 AWG.

In some examples, a near chip connector may be manufactured from one or more contact subassemblies (also referred to as wafers). Each wafer may include multiple sets of contact tips, with each set of contact tips connecting to the same cable, such that the multiple sets of contact tips of a contact subassembly connect to multiple cables. In some examples, all of the contact tips for wafer may be aligned in a row extending from a side of the wafer. The contact tips may be uniformly spaced across the row, or, in other examples, the spacing of contact tips within each set may be uniform, but there may be greater edge-to-edge spacing between sets of contact tips than within the sets.

Each set of contact tips may include one or more signal contact tips and one or more ground contact tips. For terminating a twinax cable, for example, each set of contact tips may include a pair of signal contact tips between two ground contact tips. The ground contact tips within a wafer may be connected through one or more conductive networks, while the signal contact tips may be electrically separated from each other and from the ground network(s). The planar array of contact tips of the connector, which includes contact tips of all the wafers, may occupy an area of 15.5 square millimeters or less.

Generally, the signal contact tips may be tips of signal conductors and the ground contact tips may be tips extending from a ground plate. The signal contact tips and ground contact tips may be formed as a set of contact beams of extending from a metal member (e.g., plate) and may serve as mating portions for portions of cables. The metal member may be stamped and include the multiple sets of contact beams extending from one edge of a body of a plate. In this example, the body of the metal member forms a portion of the network interconnecting the ground contact tips.

In some examples, signal conductors (including the signal contact tips), may be stamped from the same sheet of metal as the metal member forming the ground network. The signal conductors, though mechanically separated from the ground network in the finished connector, may be held within the wafer via insulative material affixed to an intermediate portion of the signal conductors and to the metal member. The insulative material may leave the signal contact tips of the signal conductors exposed for pressure mounting to a substrate. The insulative material also may leave tails of the signal conductors exposed for attaching wires of a cable to the signal conductors. In some embodiments, the insulative material may be a plastic overmold. The insulative material may also be added closer to a second edge, opposite the edge of the metal member with the contact beams, to act as spacers or other support structures for the cables connected to the signal contact tips of the subassembly.

A wave shield assembly may be affixed to the metal member. The wave shield assembly may include a corrugated member. The wave shield may be formed, for example, from stainless steel stamped to have a corrugated shape with alternating peaks and valleys. A shorting bar may extend from the corrugated structure of the wave shield. The shorting bar may follow the corrugated structure by including raised portions and lower portions. The lower portions may contact the ground contact tips of the metal member when the wave shield assembly is affixed to the metal member, while the raised portions may be positioned to avoid contact with the signal contact tips of the metal member.

Though the shorting bar may have a corrugated structure similar to the wave shield and may be integrally formed with the wave shield, the height of the peaks of the shorting bar may be less than the height of the peaks of the body of the wave shield, which may be over the cables and tails of the signal conductors. Such a configuration may provide a desired impedance profile along the length of the signal conductors, through the wafer to the tips of the signal conductors.

Such a shorting bar may be formed from multiple projections extending from an edge of the body of the wave shield. The projections may be electrically coupled to each other. Each projection may have a first portion, extending in a direction that parallels the ground contact tips and signal contact tips of the wafer. Each projection may have a second portion, transverse to the first portion. The second portions may electrically couple to an adjacent projection. The projections forming the shorting bar may extend from the valleys of the wave shield, and the first portion of each projection may be electrically coupled to one or more adjacent ground contact tips. The second portion of each projection may span some or all of the signal contact tips adjacent the one or more ground contact tips.

Adjacent projections may be electrically connected. As a specific example, the projections may be L-shaped or T shaped, with second portions extending perpendicularly to the first portions in one or both directions and parallel to the row of contact tips. Electrical connection of the projections may be made through the second portions. In some examples, the second portions of adjacent projections may extend towards each other and may overlap. The overlap may enable contact between the overlapping second portions to provide electrical connection between them. Alternatively, the overlapping portions may be sufficiently close to each other that they may be capacitively coupled across a small gap. Optionally, the second portions may be affixed to one another, such as via welding.

A wave shield assembly may also include a stamped stiffener to increase stiffness of the wafer and mitigate bowing under load. The stiffener may include a set of feet that are mechanically secured to the metal member. The stiffener may be welded to the wave shield. The wave shield assembly may be welded (e.g. laser welded) to the metal member. The shorting bar may extend from the wave shield and not be covered by the stiffener.

The wafers may be arranged within a connector for high density interconnection. According to exemplary embodiments, a wafer assembly may include a number (e.g., four) of wafers arranged along one dimension. Each of the wafers may include a number (e.g., four) of sets of contact beams that facilitate connection to a corresponding number (e.g., four) of cables along another dimension, perpendicular to the first.

The inventors have recognized and appreciated that approximately 4 sets (e.g. 3-5 sets) of contact beams per wafer provides a desirable compromise between density of interconnects and electrical performance. Longer wafers, even with stiffeners as described herein, tend to flex an undesirable amount, which results in unreliable connections for sets near the central portion of the wafer and can lead to signal distortion that interferes with high performance operation.

A wafer holder may hold the wafers to form a wafer assembly. The wafer holder may be formed of metal, such as by stamping and bending, and may include a plurality of wafer engagement features. The wafer holder may be formed from multiple members, including multiple bump outs attached to parallel side walls of the wafer holder. The bump outs may similarly be formed from metal such as by stamping and bending. Each bump out may include a wafer attachment feature. The bump outs may be attached to the side walls, such as by welding into slots on the sides of the wafer holder. Each wafer may be held between a side wall of the wafer holder, without a bump out, and a bump out on an opposite side wall.

The wafers may be arranged such that the contact beams of different wafers are parallel but in different planes (i.e., no two wafers are between the two side walls of the wafer holder in a same plane). Only one bump out may contact each wafer, and the side of the wafer coupled to a bump out may alternate among the wafers such that adjacent wafers are not coupled to a bump out on the same side (i.e., attached to the same side wall). As a result, adjacent wafers may be offset from each other between the two side walls of the wafer holder. The offset may be parallel to the row of contact tips of the wafer. Such a configuration may enhance signal integrity, such as by reducing cross talk.

The wafer assembly may be placed into a housing, and a strain relief structure may be engaged with the housing to hold cables terminated to the wafers relative to the housing. The strain relief structure may include one or more engagement members, each of which straddles a portion of the housing to engage with the housing. A clamp plate secured to the strain relief structure, in combination with an end of the strain relief structure, may define an opening for cables. Interleafs in the opening may separate the cables being directed into the connector and to the different wafers. A cover may be added to cover the wafers held in the housing.

The housing, including the wafer assembly, may be placed within a fence attached to a surface of a substrate (e.g., printed circuit board (PCB)). The fence may be configured as a frame around the contacts on the substrate, such as the PCB, below to which the wafers connect. The fence may be soldered onto the substrate or otherwise attached to the substrate to both define the location in which the connector is to be mated to the substrate and to latch the connector against the substrate, providing a force on the connector that presses the contact tips against pads on the substrate for reliable mating. In some examples, the cover includes features that engage the fence when the connector is pressed against the substrate to provide the mating force.

In some examples the fence may be provided and/or used with a pick and place cover. The pick and place engage features of the fence, which may be the same features that the connector cover engages. Though the fence has no substantial upper surface for grasping by a pick and place machine, the cover may provide such a surface, facilitating manufacture of an electronic assembly using a pressure mount connector as described herein.

The foregoing and additional features are illustrated in the attached drawings.

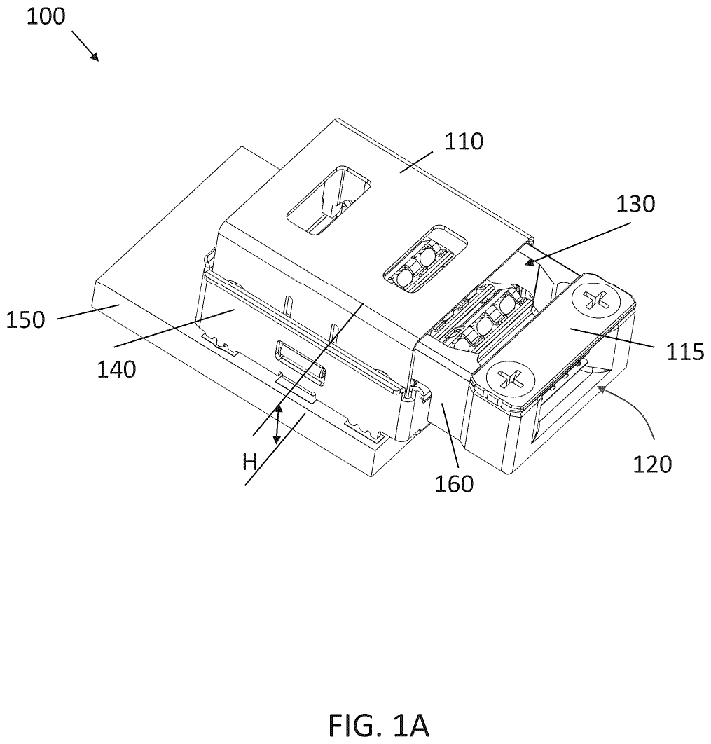

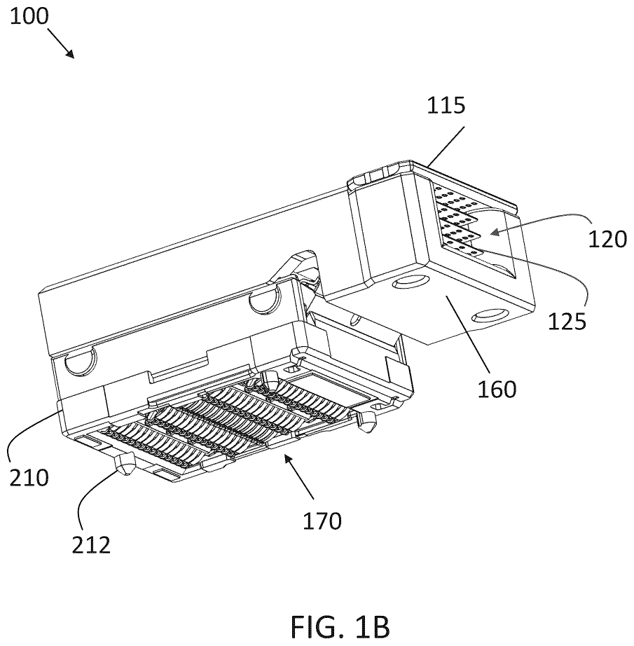

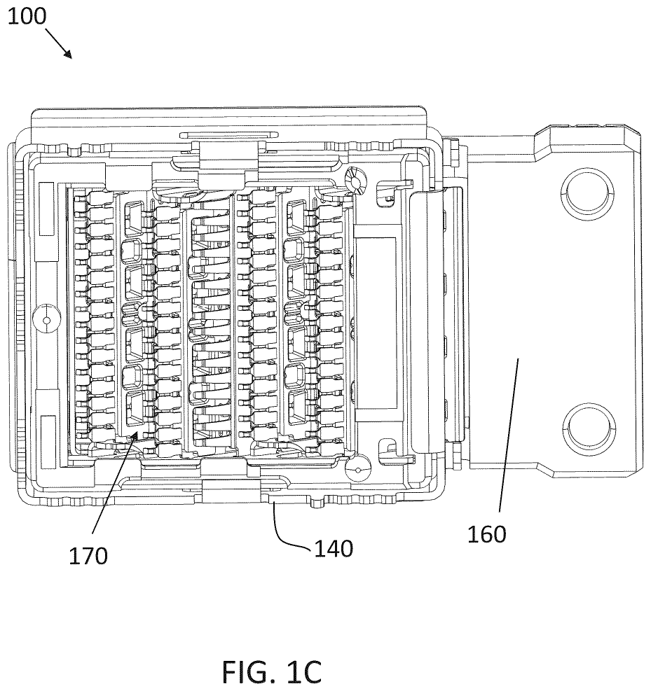

FIG. 1A is a top perspective view of a connector 100 according to some embodiments. The connector 100 is shown interfaced with a substrate 150. In the figures a printed circuit board (PCB) is shown as a non-limiting exemplary substrate, but a semiconductor chip substrate or other substrate may be used based on the application. Substrate 150 illustrates a portion of a substrate to which a connector 100 may be mounted. The substrate, for example, may include semiconductor chips, connectors and/or other components, which are not illustrated or simplicity.

A cover 110 is shown over a wafer assembly 130, which includes multiple contact subassemblies, here referred to as wafers 135. A total height H of the connector 100 may be on the order of less than 12 millimeters, such as between 4 and 12 mm for example.

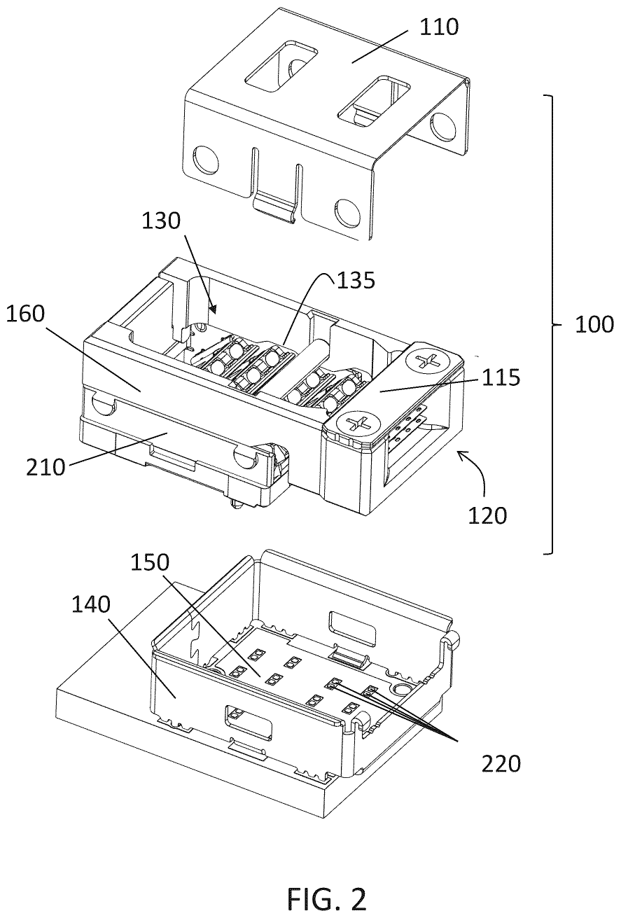

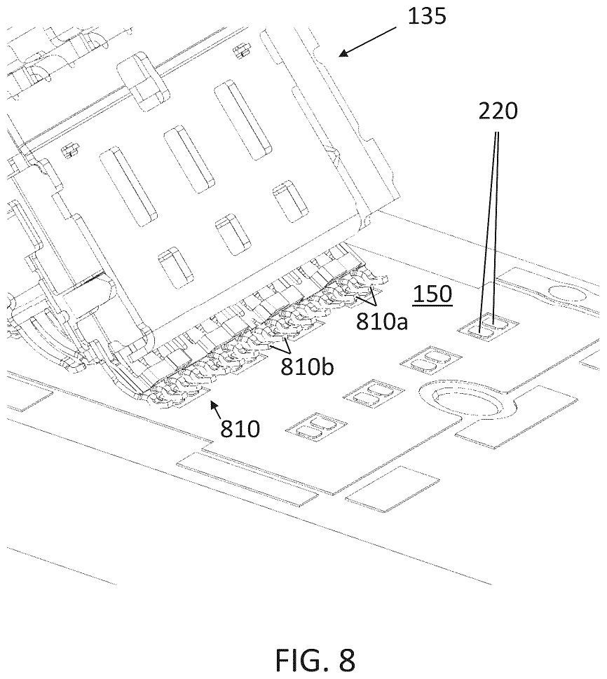

A fence 140 frames an area of the substrate 150 where the wafers 135 of the connector 100 are mounted. The fence 140 may be soldered onto the substrate 150 or otherwise attached to the substrate 150 to both define the location in which the connector 100 is to be mated to the substrate 150 and also to latch the connector 100 against the substrate 150. Fence 140 may provide a force on the connector 100 that presses the contact tips 810 (FIG. 8) of the connector 100 against corresponding contact areas 220 (FIG. 2) of the substrate 150 for reliable mating.

Connector 100 may include a housing (210, FIG. 2), holding the wafer assembly. A strain relief structure 160 may be coupled to the housing and may hold cables terminating at the wafers 135, such that force on the cables will not be transmitted to the termination locations of the cables within the wafers. In the example of FIG. 1A, the cables are shown cutaway at the wafers 135 for simplicity of illustration, but may extend from the wafers through an opening such that the cables can then be routed to other portions of an electronic system. A clamp plate 115 secured to the strain relief structure 160, together with an end portion of the strain relief structure 160 to which it is secured, may define an opening that is a cable entrance 120 for cables that terminate at the wafers 135. Tightening the clamp plate, such as with screws as pictured, may compress cables against the strain relief structure 160.

FIG. 1B is a bottom perspective view of the connector 100 of FIG. 1A with the cover 110 removed. Interleafs 125 at the cable entrance 120 are visible in this view. The interleafs 125 may separate and support cables entering the connector 100 via the cable entrance 120.

The substrate 150 and fence 140 are hidden in FIG. 1B to show the mounting face 170 with contact tips 810 (FIG. 8) of the wafers 135, which are further discussed below. In this example, housing 210 includes alignment posts 212 that may fit into holes in a substrate. The alignment posts 212 may be configured to fit into holes in the substrate that have the same relationship with respect to pads on the surface of the substrate 150 that the alignment posts 212 have with respect to contact tips at the mounting face 170 of the connector.

FIG. 1C is a bottom view of the connector 100, including fence 140, though not mounted to a substrate 150. FIG. 1C shows the arrangement of sets of contact tips 810 of the wafers 135. As the wafers are aligned side-by-side in parallel, their contact tips are aligned in parallel rows.

FIG. 2 is a partially exploded view of connector 100. The fence 140 is shown framing contact areas 220 on a surface of the substrate 150. In this example, a surface of substrate 150 has a conductive plating, which may be connected to ground and serve as a ground plane. Contact areas are formed within openings in this ground plane. One or more signal pads may be formed on the surface of substrate 150 within these openings. Contact tips of the wafers 135 may press against and form electrical connections wafers 135 to these conductive structures on the substrate. The ground conductors within connector 100 may press against the ground plane and signal conductors may press against the pads within the contact areas 220. A housing 210 of the connector 100 and may be seated within the fence 140. The strain relief structure 160 straddles an end of the housing 210, as shown.

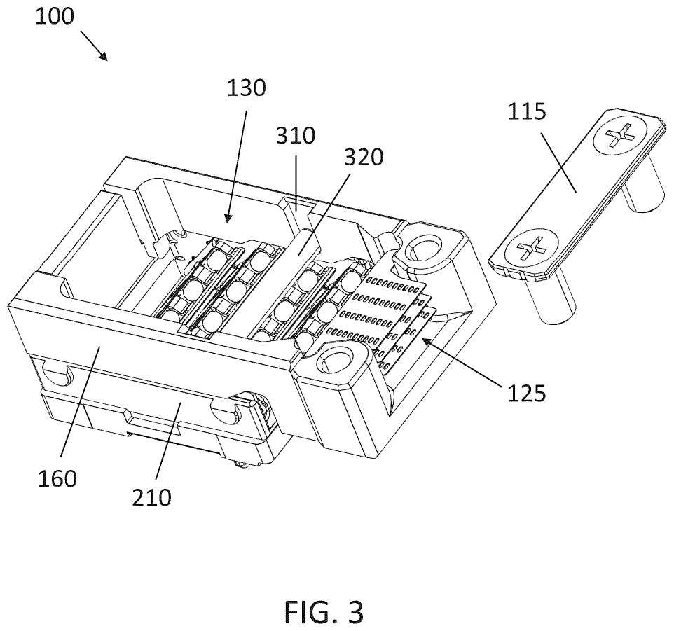

FIG. 3 is a top perspective view of a connector 100 according to some embodiments. The clamp plate 115 is shown separated from the strain relief structure 160. This provides a clearer view of the interleafs 125 used to separate and support rows of cables entering the connector 100. With the cover 110 omitted, FIG. 3 shows a bar 320 that slides into grooves 310 on the sides of the strain relief structure 160. The bar 320 is engaged with the strain relief structure 160 and may serve a mechanical support function, such as to keep the wafer assembly 130 in place within the housing 210 and or to guide cables terminated to the wafers 135 from cable entrance 120.

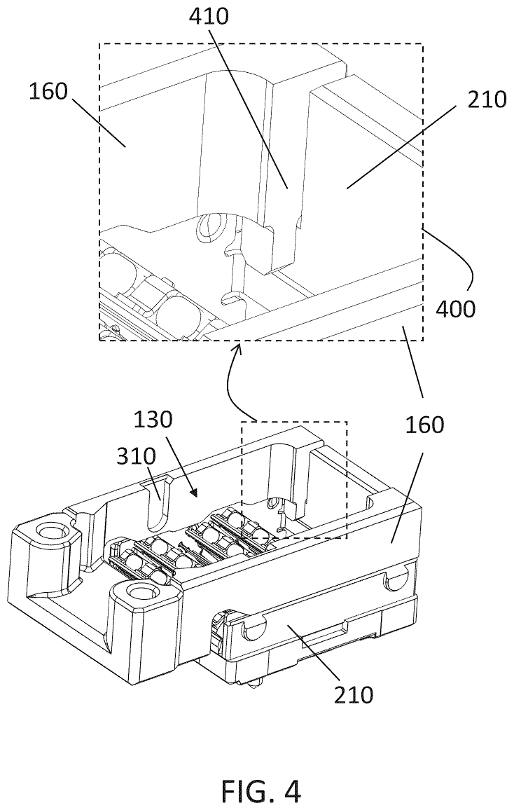

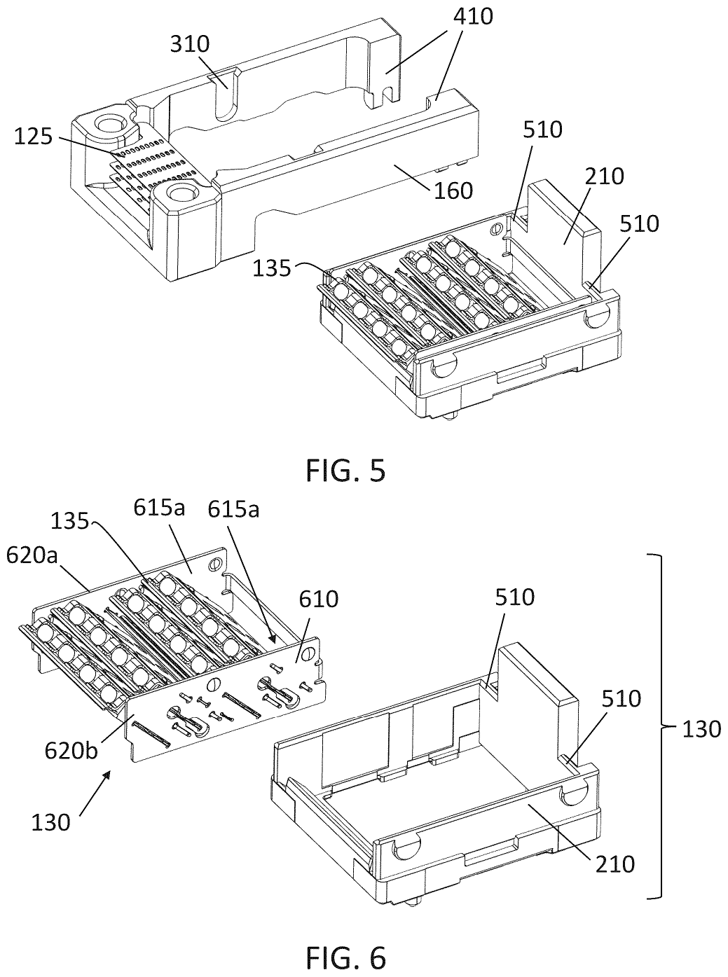

FIG. 4 is a perspective view of connector 100 according to some embodiments. Strain relief structure 160 may be attached to housing 210. Attachment may be provided by complementary snap fit features, for example. An enlarged view is provided in callout 400 of an exemplary interface between the strain relief structure 160 and housing 210. An engagement feature 410 of the strain relief structure 160 engages with a ledge 510 of the housing 210, which is visible in FIG. 5. Two engagement features 410 engaged with ledges 510 on opposite sides of an end of the housing 210 resist lateral movement of the strain relief structure 160 relative to the housing 210.

FIG. 5 is an exploded view of connector 100 according to some embodiments. The strain relief structure 160 is shown separated from the housing 210. The groove 310 on one side of the strain relief structure 160, in which a bar 320 may be slid into place, and the engagement features 410 on two sides of the same end of the strain relief structure 160 are shown. The engagement features 410 are on an end opposite the end with the interleafs 125. The ledges 510 of the housing 210 and the wafer assembly 130 within the housing 210 are also shown.

FIG. 6 is an exploded view of aspects of a connector 100, showing a wafer assembly 130 separated from housing 210. Wafer subassembly may include a wafer retainer 610 and one or more wafers 135. The exemplary wafer retainer 610 is shown to hold four wafers. In this example, the wafers are held in parallel, with four wafers 135 between a first side wall surface 615a of a first side wall 620a and a second side wall surface 615b of a second side wall 620b, facing the first side wall surface 615a. The wafer retainer 610 may be formed of metal, such as by stamping and bending.

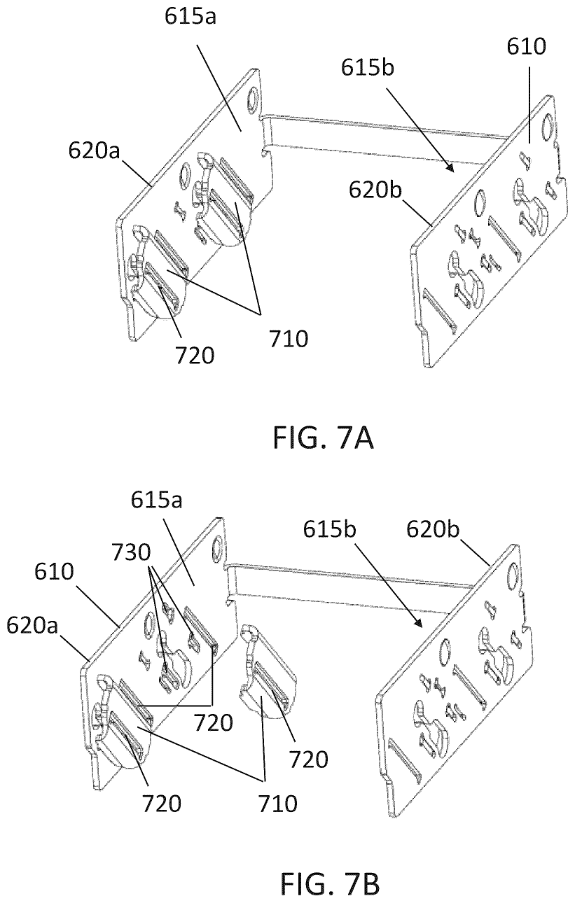

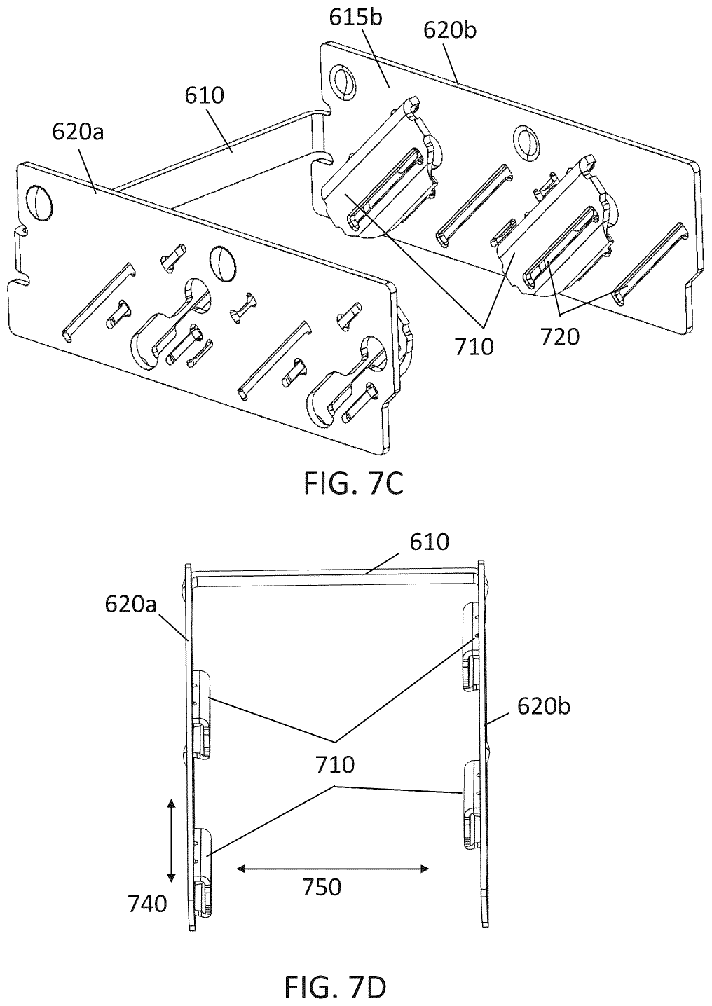

FIGS. 7A-7D are various views of a wafer retainer 610 according to some embodiments. FIG. 7A is a perspective view of the wafer retainer 610 that shows bump outs on the first side wall surface 615a. Bumb outs may be implemented as spacers 710, which in this example are separate members attached to the side walls. In other examples, the bump outs may be integrally formed with the side walls, such as via embossing or other metal forming operation. The spacers 710 visible in FIG. 7A project from the first side wall surface 615a and function to offset adjacent rows of wafers 135 from each other. Each spacer 710 may be formed from metal such as by stamping and bending and may include a wafer engagement feature 720 that allows a wafer 135 (specifically a metal member 1210 (i.e., wafer)) to be engaged with the spacer 710. The side walls 620a, 620b may also include wafer engagement features 720. In the example illustrated, the wafer engagement features are slits into which projections from the wafer may fit. In the illustrated example, the projections are intended to be welded to the side walls 620a, 620b, but other engagement mechanisms, such as interference fit, may alternatively or additionally be used.

FIG. 7B shows one of the spacers 710 separated from the first side wall surface 615a to reveal slots 730 in the first side wall 620a into which the spacer 710 is inserted. The spacers 710 may be attached to the side walls 620a, 620b by welding the spacers 710 into respective slots 730 in the side walls 620a, 620b, for example. According to the views shown in FIGS. 7A and 7B, from front to back, the first side wall 620a of the exemplary wafer retainer 610 includes a spacer 710 with a wafer engagement feature 720, a wafer engagement feature in the first side wall 620a, another spacer 710 with a wafer engagement feature 720, and another wafer engagement feature 720 in the first side wall 620a.

FIG. 7C shows a perspective view of the wafer retainer 610 that reveals the spacers 710 attached to the second side wall 620b. According to the view shown in FIG. 7C, from front to back, the second side wall 620b of the exemplary wafer retainer 610 includes a wafer engagement feature in the second side wall 620b, a spacer 710 with a wafer engagement feature 720, another wafer engagement feature 720 in the second side wall 620b, and another spacer 710 with a wafer engagement feature 720. As compared with the arrangement of spacers 710 attached to the first side wall 620a, the spacers 710 attached to the second side wall 620b are offset. That is, each spacer 710 on one of the side walls 620a, 620b is across from a wafer engagement feature 720, rather than from another spacer 710, on the opposite side wall 620b, 620a.

FIG. 7D is a top view of wafer retainer 610. This view shows the offset in the arrangement of the spacers 710 on the side walls 620a, 620b. According to the arrangement in the exemplary wafer retainer 610, again moving from front to back (in a first direction 740), a first wafer 135 would engage the wafer engagement feature 720 of the spacer 710 attached to the first side wall 620a on one side and would engage the wafer engagement feature 720 in the second side wall 620b on the opposite side. As a result, the first wafer 135 would not be centered between the side walls 620a, 620b, but would instead be closer to the second side wall 620b.

A second wafer 135, parallel to the first wafer subassembly in the first direction 740, would engage the wafer engagement feature 720 in the first side wall 620a on one side and would engage the wafer engagement feature 720 of the spacer 710 attached to the second side wall 620b on the opposite side. As a result, the second wafer 135 would not be centered between the side walls 620a, 620b, but would instead be closer to the first side wall 620a. In this way, adjacent wafers 135 are held in the wafer retainer 610 in parallel in the first direction 740 but are offset differently from each other in the second direction 750. These alternating offsets enable staggered rows of contact areas 220, which may be beneficial for signal integrity.

FIG. 8 is a perspective view of connector 100 with supporting structures removed to reveal wafers 135 when mated to a substrate. A wafer 135 is removed to show the contact areas 220 of the substrate 150. An exemplary wafer 135 is shown to include four sets of contact tips 810 associated with four cables. Each of the four sets of contact tips 810 includes two signal contact tips 810a and two ground contact tips 810b. In an exemplary case, a wafer assembly 130 may include four wafers 135 arranged along the first direction 740, parallel to each other. Each of the four wafers 135 may include four sets of contact tips 810 along the second direction 750 for a total of sixteen sets of contact tips 810 in the wafer assembly 130. An area on the substrate 150 to which the connector 100 is mated (e.g. the connector footprint) may be smaller than 250 square millimeters, or less than 15.5 square millimeters, in some examples, such as approximately 230 square millimeters.

A wafer 135 with three to five sets of contact tips 810, associated with three to five cables, may balance a desire for increased density of interconnects with a desire for electrical performance. While increasing the number of sets of contact tips 810 increases density, the longer metal member 1210 in the second direction 750 that is required for the increased number of sets of contact tips 810 may be more prone to flex by an undesirable amount. The flex may disrupt the contact between the connector 100 and the substrate 150, resulting in unreliable connections, especially nearer the central portion of the wafer 135. This, in turn, can result in signal distortion that interferes with high speed operation.

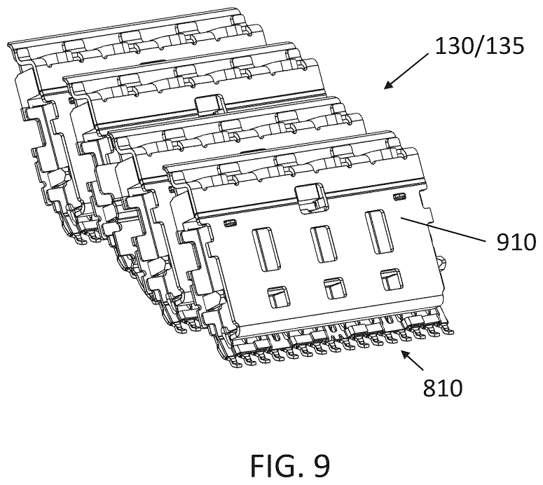

FIG. 9 is a perspective view of multiple wafers, positioned as they might be held within an exemplary wafer assembly 130. In this example, four wafers 135 are shown. Each wafer 135 may include a stiffener 910 to increase stiffness and mitigate bowing under load.

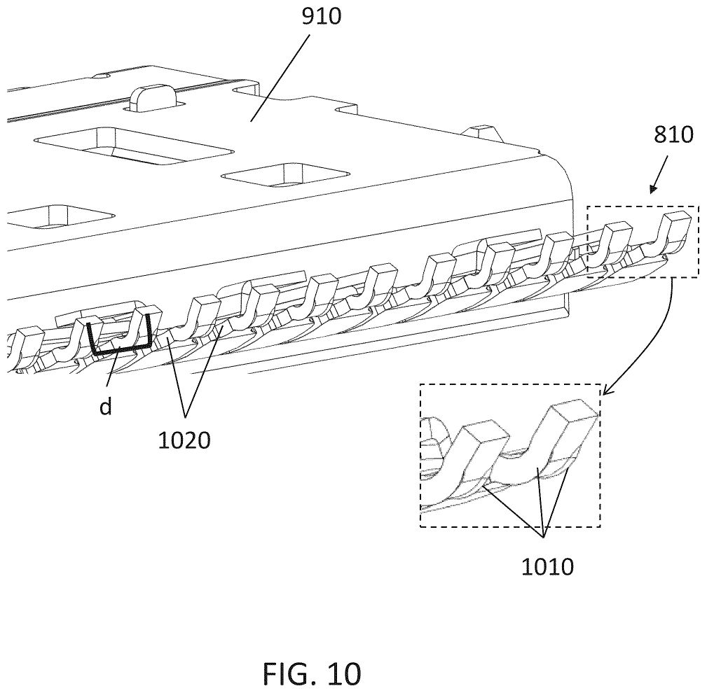

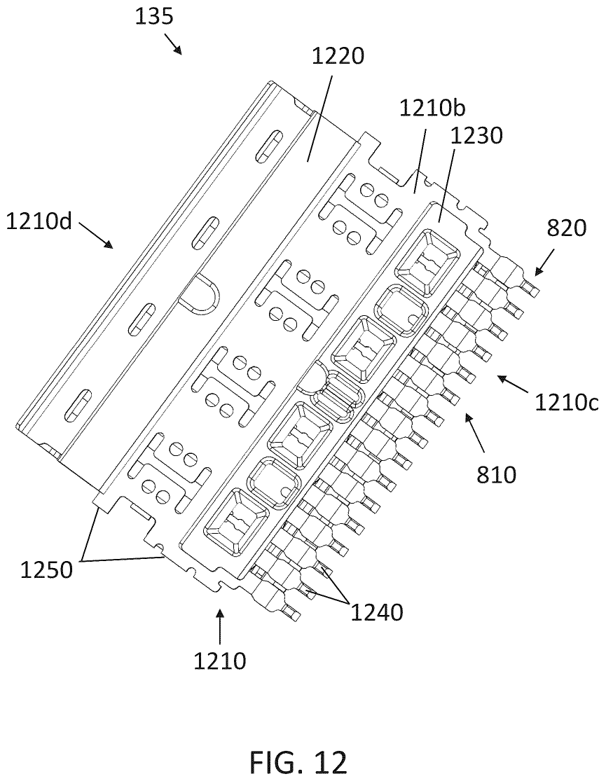

FIG. 10 shows an enlarged view of a portion of a wafer 135 according to some embodiments. An expanded view of contact tips 810 shows that mating surfaces may be shaped (e.g., may have a convex contact surface) to make reliable contact based on a small amount of force. That is, the connector 100 may be a pressure mount connector and electrical connection between the signal contact tips 810a and contact areas 220 of the substrate 150 may be facilitated by force on the contact areas 220 generated by deflection of signal contact tips 810a. The edges of the contact surfaces 1240 (FIG. 12) may protrude as bite marks or projections 1010 that decrease the contact area and result in a relatively large pressure on the contact areas 220 even with a relatively small normal force (e.g., on the order of less than 40 grams of normal force). The large pressure may pierce oxides or other contaminants on the contact areas 220, leading to more reliable connections. The projections 1010 may be formed by coining the edges of contact beams 1020 that terminate to the contact tips 810. The contact surfaces 1240 associated with signal contact tips 810a may touch the contact areas 220 of the substrate 150 but need not touch if adequate electrical coupling is provided through the projections 1010.

The pitch, the center-to-center distance d between adjacent contact tips 810, may be less than 1.0 millimeters (mm). For example, the pitch may be 0.6 mm. The center-to-center distance between pairs of signal contact tips 810a may be less than 3.5 mm (e.g., 3.2 mm). The contact tips 810 may be uniformly spaced across the row, or, in other examples, the spacing of contact tips 810 within each set may be uniform, but there may be greater edge-to-edge spacing between sets of contact tips 810 than within the sets.

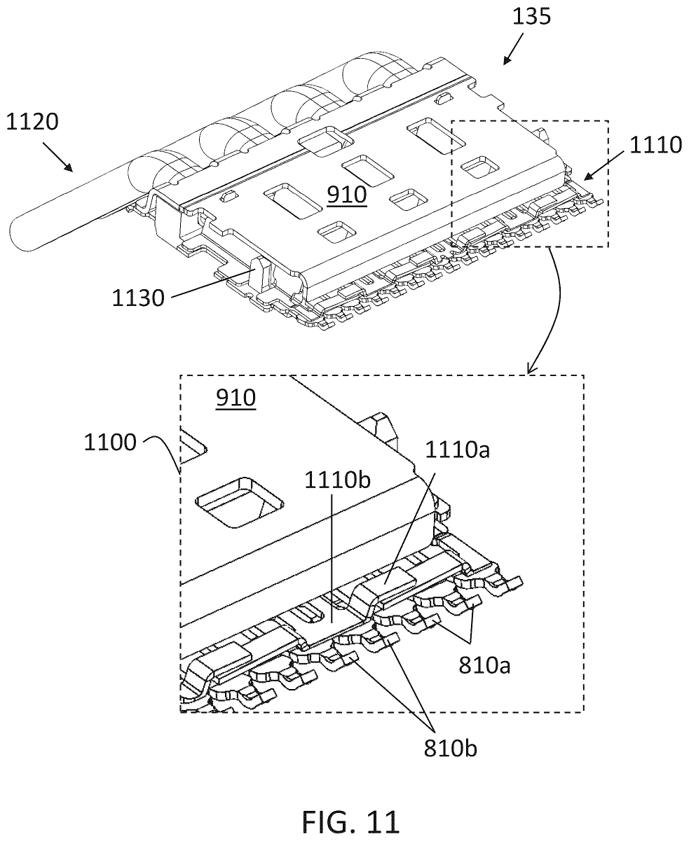

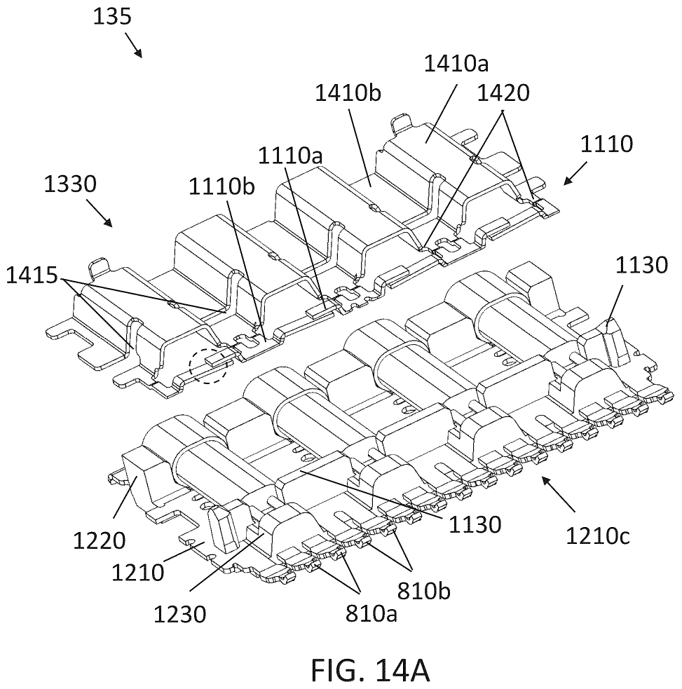

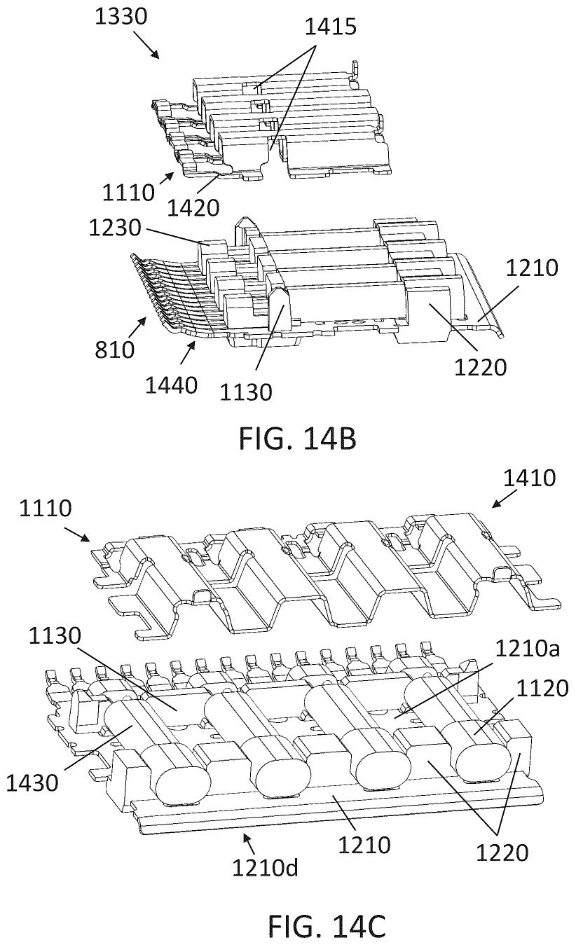

FIG. 11 shows an exemplary wafer 135 according to some embodiments. A shorting bar 1110 is shown over the contact tips 810. Call out 1100 shows that the shorting bar 1110 includes higher segments 1110a and lower segments 1110b. The lower segments 1110b of the shorting bar 1110 contact the ground contact tips 810b while the higher segments 1110a of the shorting bar 1110 are above, but not in contact with, the signal contact tips 810a. Cables 1120 are shown at the opposite end of the wafer 135 from the contact tips 810. An insulative material 1130 is shown on the sides of the wafer 135. This insulative material 1130 may aid in the alignment of a wave shield 1330 with the metal member 1210 (i.e., wafer), as discussed with reference to FIG. 14A.

FIG. 12 is a bottom perspective view of a wafer 135 according to some embodiments. The view in FIG. 12 shows the opposite side of the wafer 135 as compared to the view in FIG. 11, which shows the stiffener 910. The view in FIG. 12 shows the wafer or metal member 1210 with insulative material 1220 to hold cables 1120 in place and insulative material 1230 to hold conductors in place. A first surface 1210a of the metal member 1210 (e.g., top surface according to the orientation shown in FIG. 11) is not visible in FIG. 12. A second surface 1210b (e.g., bottom surface according to the orientation in FIG. 11), which is opposite the first surface 1210a, is shown. The contact tips 810 are on a first side of the metal member 1210 and extend from a first edge 1210c, and the cables enter the wafer 135 at the opposite second edge 1210d.

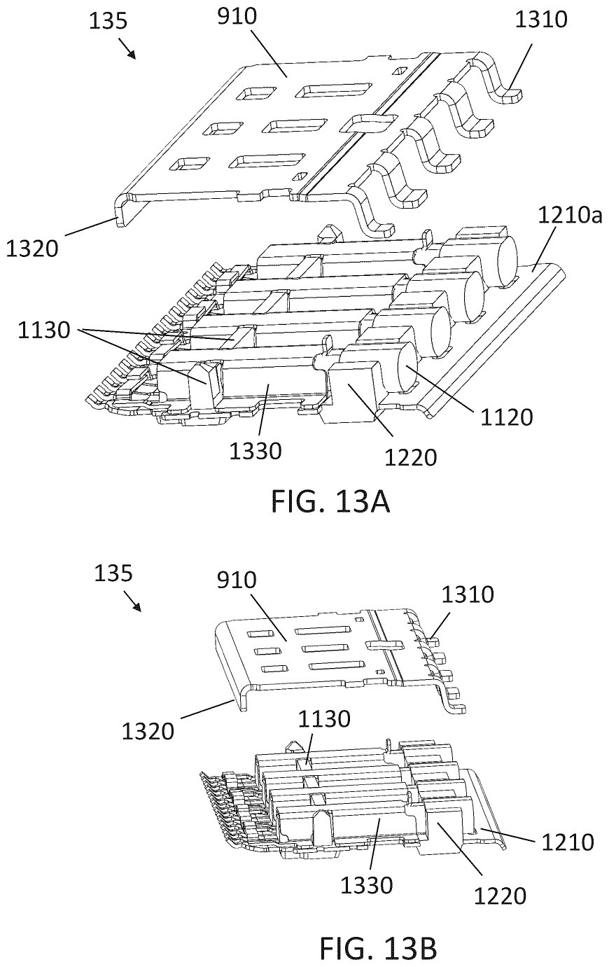

FIGS. 13A and 13B show an exploded view of aspects of a wafer 135 according to some embodiments from different perspectives. The stiffener 910 is shown separated from the remainder of wafer 135. A wave shield 1330 below the stiffener 910 is visible. FIG. 13A shows a set of feet, securing features 1310, of the stiffener 910 that may be used to mechanically secure the stiffener 910 to metal member 1210. The securing features 1310 may be welded (e.g., laser welded) to a first surface 1210a of the metal member 1210, for example. FIG. 13B shows a lip 1320 of the stiffener 910 that may prevent movement of the cables between the end with the securing features 1310 and the end with the lip 1320.

In FIG. 12, the insulative material 1220 is shown as a solid piece on the second surface 1210b of the metal member 1210. FIGS. 13A and 13B show gaps in the insulative material 1220 adhered to the first surface 1210a of the metal member 1210. The gaps are sized to receive and separate cables 1120. The insulative material 1130 is also shown with gaps that accommodate the cables 1120 and the wave shield 1330 over the cables 1120. The insulative material 1230 is below the wave shield 1330 and is not visible in FIGS. 13A and 13B.

FIGS. 14A-14C show exploded views of aspects of a wafer 135 according to some embodiments. The figures show a wave shield 1330 separated from the metal member 1210. The wave shield 1330 may be welded to the stiffener 910, and both the wave shield 1330 and the stiffener 910 may be welded (e.g., laser welded) to the metal member 1210. Though, in alternative examples, the parts may be assembled in different orders, such as attaching the stiffener to the wave shield after the wave shield is attached to metal member 1210.

FIG. 14A is a view showing the first edge 1210c of the metal member 1210. The wave shield 1330 may be formed, for example, from stainless steel stamped to have the corrugated shape shown in the figures. That is, the wave shield 1330 includes alternating peaks or higher areas 1410a, which accommodate cables 1120 below, and valleys or lower areas 1410b, which contact the metal member 1210 and may be affixed (e.g., laser welded) to the metal member 1210. The wave shield 1330 also includes alignment cutouts 1415 that align with the insulative material 1130 on the metal member 1210. Insertion of the insulative material 1130 on the metal member 1210 into the alignment cutouts 1415 of the wave shield 1330 facilitates aligning and maintaining a position of the wave shield 1330 relative to the metal member 1210.

FIG. 14B is a side view of the wave shield 1330 and metal member 1210. The shorting bar 1110 is shown as extending from the wave shield 1330 and may not be covered by the stiffener 910. The shorting bar 1110 may be integrally formed with the wave shield 1330. The shorting bar 1110 extends from the wave shield 1330 via projections 1420 that are perpendicular to the shorting bar 1110 and parallel to the contact beams 1440 that terminate in the contact tips 810.

The projections 1420 extend from the lower areas 1410b of the wave shield 1330 and may be electrically coupled to one or more adjacent ground contact tips 810b. Each projection 1420 may extend to a portion of the shorting bar 1110 in an L-shape (e.g., on the two ends of the shorting bar 1110) or in a T-shape with a higher segment 1110a on one side of the T and a lower segment 1110b on the other side of the T. The higher segments 1110a of the shorting bar 1110 associated with projections 1420 on either side of the same set of contact tips 810 may overlap, as highlighted by the dashed circle in FIG. 14A, and may facilitate electrical contact over the length of the shorting bar 1110. The overlapping portions of the higher segments 1110a of the shorting bar 1110 may be capacitively coupled or may be affixed to each other (e.g., via welding).

As noted, the shorting bar 1110 may also be corrugated and generally follow the shape of the wave shield 1330 with higher segments 1110a, which align with signal contact tips 810a but do not contact the signal contact tips 810a, and lower segments 1110b, which align with and contact ground contact tips 810b. The higher segments 1110a of the shorting bar 1110 may correspond with but be lower that the higher areas 1410a of the wave shield 1330, as shown. The exemplary configuration may provide a desired impedance profile along a length of the signal conductors through the metal member 1210 to the signal contact tips 810a. In the embodiment illustrated, a path length in a side to side direction along the portion of the corrugated shield overlying the cables may be longer than a path length in a side to side direction along the shorting bar, which would conventionally be difficult to simply form as a stamping from a single sheet of metal. The illustrated component may be simply formed as the overlapping segments of the shorting bar compensate for differences in these path lengths.

FIG. 14C is a view showing the second edge 1210d of the metal member 1210, which may be angled down, according to the side view in FIG. 14B. Portions of the cables 1120 are shown in the gaps of the insulative material 1220. Exposed shields 1430 of the cables 1120 are shown between the insulative material 1220 and the insulative material 1130.

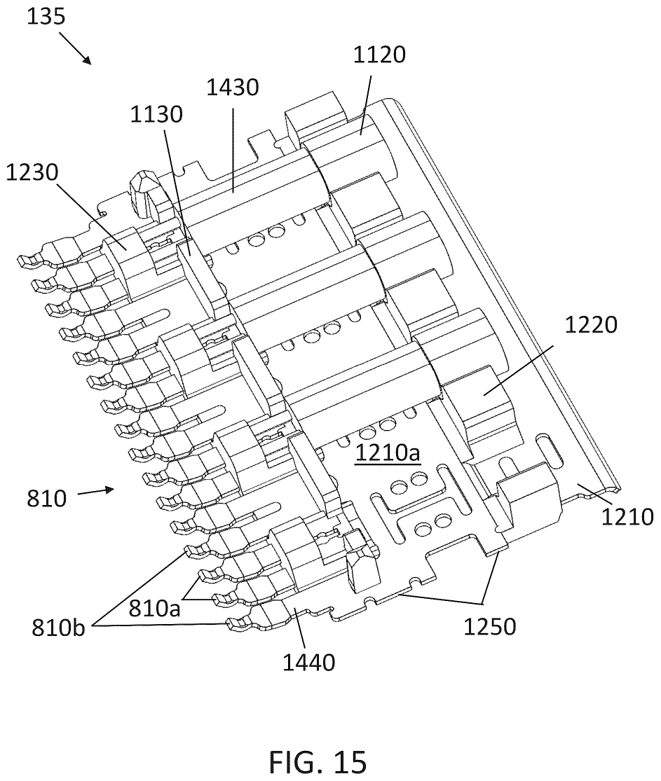

FIG. 15 is a perspective view of the metal member 1210 of a wafer 135 according to some embodiments. In this example, multiple regions of insulative material molded to metal member 1210 and signal conductors cut from the same sheet from which metal member 1210 was formed are shown, as are cables terminated to tails of signal conductors. One of the cables 1120 is omitted to show areas of the metal member 1210 below the cables 1120. Signal contact tips 810a and ground contact tips 810b, arranged on either side of the signal contact tips 810a, are indicated for one of the four sets of contact tips 810, associated with four cables 1120, that terminate at the exemplary wafer 135. The insulative material 1230 is shown aligned with the signal contact tips 810a and insulates the signal contact beams 1440 from the ground plane represented by the wafer (metal member 1210).

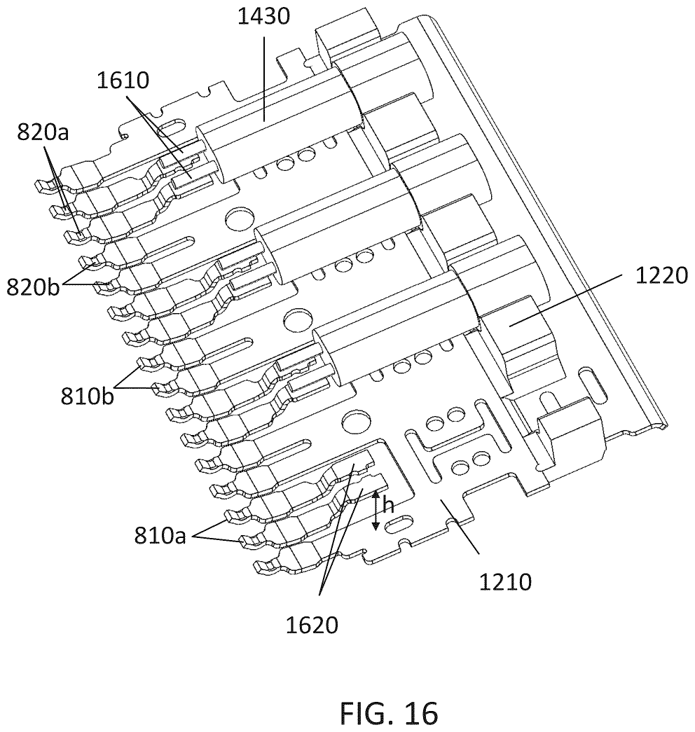

FIG. 16 is a perspective view of the metal member 1210 shown in FIG. 15 with the insulative material 1130, used for alignment of the wave shield 1330 with the metal member 1210, and the insulative material 1230, used to hold the signal conductors, omitted. This view shows that wires, conductors 1610, extending from the exposed shield 1430 of the cables 1120 connect to tails, conductive pads 1620, on the opposite end of the signal contact beams 1440 from the signal contact tips 810a.

The conductors 1610 may have a diameter less than or equal to 32 AWG. In some embodiments, the conductors 1610 may have a diameter less than or equal to 27 AWG. The insulative material 1230, as well as insulative material 1220, may be a plastic overmold, for example. As indicated in FIG. 16, the conductive pads 1620 of the signal contact beams 1440 may be out of plane with the first surface 1210a of the metal member 1210 and, specifically, may be at a height h above the first surface 1210a of the metal member 1210.

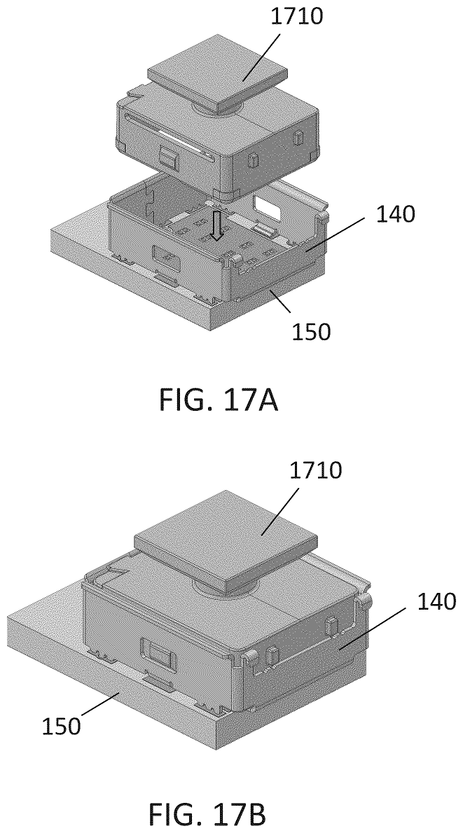

FIG. 17A shows a perspective view of a fence 140 of a connector prior to engagement with a pick and place cap 1710. As noted with reference to FIG. 1A, the fence may be soldered or otherwise attached to the substrate 150 and frames an area of the substrate 150 where the wafers 135 are mounted (e.g., pressure mounted). FIG. 17B shows the pick and place cap 1710 engaged within the fence 140. When the pick and place cap 1710 is engaged with the fence 140, as shown in FIG. 17B, the pick and place cap 1710 may be used to position the substrate 150 and fence 140 prior to pressure mounting of the wafers 135.

In a first example, a contact subassembly for an electrical connector includes a first plurality of contact beams at a first side of the contact subassembly, a conductive network interconnecting the first plurality of contact beams, and a second plurality of contact beams interspersed with the first plurality of contact beams. Each of the second plurality of contact beams includes a portion of a contact of a plurality of contacts. A corrugated member includes a body including valleys electrically and mechanically connected to the conductive network and portions between the valleys, each of the portions aligned with and electrically separate from the portion of at least one contact of the plurality of contacts. A plurality of projections extends from the body at the first side, each of the plurality of projections is electrically connected to a contact beam of the first plurality of contact beams, and comprises a first portion integral with the body and a second portion extending in a direction transverse to the first portion. Second portions of adjacent projections of the plurality of projections are electrically connected to each other.

Optionally, the contact subassembly includes insulative material arranged on the first plurality of contact beams.

Optionally, the insulative material fits within cutout portions of the corrugated member.

Optionally, the plurality of projections may be formed as pairs of projections with the second portions of each of the pairs of projections being in an overlapping arrangement.

In a second example, an electrical connector includes a holder including a first side wall and a second side wall, a plurality of wafers mounted in parallel between the first side wall and the second side wall, and a plurality of members to engage a wafer. Each of the plurality of bump outs is attached to the first side wall or the second side wall, and each of the bump outs is between a respective wafer of the plurality of wafers and a respective sidewall of the first side or the second side wall in a staggered fashion such that each wafer of the plurality of wafers engages a side wall of the first or second side walls and a bump out of the plurality of bump outs.

Optionally, each of a first set of wafers among the plurality of wafers is separated from the first side wall through a bump out of one of the plurality of bump outs.

Optionally, each of a second set of wafers among the plurality of wafers is adjacent to one or more of the first set of wafers and is separated from the second side wall through a bump out of one of the plurality of bump outs.

In a third example, a pressure mount connector with a mating face includes a plurality of signal contacts, each of the plurality of signal contacts comprising a mating contact portion comprising a beam extending in a length direction to a distal end. The distal ends of the plurality of signal contacts are disposed in a planar array at a mating face of the pressure mount connector. The distal end of each of the plurality of signal contacts comprises a convex surface extending in a width direction perpendicular to the length direction from a first edge to a second edge. At least one of the first edge and the second edge comprises a projection extending from the convex surface.

Optionally, the pressure mount connector has a height of 12 millimeters or less.

Optionally, the plurality of signal contacts are arranged in pairs.

Optionally, center-to-center spacing between adjacent signal contacts of one of the pairs is 0.6 mm or less.

Optionally, the connector comprises 16 of the pairs and the planar array has an area of less than 15.5 square millimeters.

Optionally, each of four sets of four of the pairs is arranged in a different parallel plane in the pressure mount connector.

Optionally, each of the plurality of signal contacts provides less than 40 grams normal force.

Optionally, the connector operates at a frequency of 224 giga bits per second (Gbps) or higher.

Optionally, the pressure mount connector provides a contact width of 0.04 to 0.12 millimeters.

Optionally, in combination with a fence bounding a region and affixed to a substrate, wherein the pressure mount connector fits within the region and is configured to engage the fence, a pick and place cap fits within the region and engage the fence.

Optionally, the pressure mount connector also includes a wafer holder to hold a plurality of wafers along a first direction. Each of the plurality of wafers includes the plurality of signal contacts.

Optionally, the wafer holder includes spacers configured to offset adjacent ones of the wafers in a second direction, perpendicular to the first direction.

Optionally, the pressure mount connector includes a housing to house the wafer holder and a strain relief structure configured to engage with the housing.

Optionally, the strain relief structure includes one or more engagement members and each of the one or more engagement members straddles a portion of the housing to engage with the housing.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

Terms signifying direction, such as “upwards” and “downwards” or front and back were used in connection with some embodiments. These terms were used to signify direction based on the orientation of components illustrated or connection to another component, such as a surface of a printed circuit board to which a termination assembly is mounted or the mating face of a connector. It should be understood that electronic components may be used in any suitable orientation. Accordingly, terms of direction should be understood to be relative, rather than fixed to a coordinate system perceived as unchanging, such as the earth's surface.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The indefinite articles “a” and “an,” as used herein in the specification and in the claims, unless clearly indicated to the contrary, should be understood to mean “at least one.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

Also, the phraseology and terminology used herein are for the purpose of description and should not be regarded as limiting. The use of “including,” “comprising,” “having,” “containing,” or “involving,” and variations thereof herein, is meant to encompass the items listed thereafter (or equivalents thereof) and/or as additional items.

What is claimed is:

1. A pressure mount connector, comprising:
a plurality of contact subassemblies disposed in parallel to each other, each of the plurality of contact subassemblies comprising a plurality of contact beams;
a housing supporting the plurality of contact subassemblies, the housing comprising first and second protrusions; and
a cover comprising a top and a side wall, the side wall comprising a cantilever and first and second holes disposed on opposite sides of the cantilever, the cantilever comprising a distal end curving outwardly, wherein:
the contact beams of the plurality of contact subassemblies extend toward a bottom of the cover and a mating face of the connector at an acute angle to the top of the cover; and
the first and second protrusions of the housing extend into the first and second holes of the cover, respectively.

2. The pressure mount connector of claim 1, in combination with:
a fence bounding a region and configured to be affixed to a substrate, the fence comprising an opening,
wherein the distal end of the cantilever of the cover curves into the opening of the fence.

3. The pressure mount connector of claim 1, wherein:
the housing comprises three locating pillars positioned at vertices of a triangle, two of which are closer to a cable outlet than the third.

4. The pressure mount connector of claim 1, comprising:
a strain relief structure engaged with the housing to hold cables terminated to the contact beams of the plurality of contact subassemblies relative to the housing.

5. The pressure mount connector of claim 4, wherein:
the strain relief structure extends beyond a rear of the cover.

6. The pressure mount connector of claim 1, wherein:
each of the plurality of contact subassemblies comprises a plurality of cables, each of the plurality of cables comprising a first end coupled to one or more contact beams of the plurality of contact beams and a second end extending out of a rear of the cover.

7. The pressure mount connector of claim 1, wherein, for each of the plurality of contact subassemblies:
the plurality of contact beams comprise a plurality of first contact beams electrically connected to each other, a plurality of sets of second contact beams interspersed with the plurality of first contact beams such that adjacent sets of second contact beams are separated by two first contact beams, which have a slot therebetween and are joined at tails.

8. The pressure mount connector of claim 7, comprising:
a shorting bar comprising raised portions and lower portions,
wherein the lower portions contact the plurality of first contact beams, and the raised portions are positioned to avoid contact with respective sets of the plurality of sets of second contact portions.

9. The pressure mount connector of claim 8, comprising:
a corrugated member comprising valleys electrically connected to the plurality of first contact beams, and portions between the valleys, each of the portions aligned with a respective set of second contact beams of the plurality of sets of second contact beams and contacting a shield of a cable terminated to the respective set of second contact beams.

10. The pressure mount connector of claim 8, comprising:
a stiffener covering tails of the plurality of sets of second contact beams, wherein:
the plurality of sets of second contact beams comprise contact tips extending beyond the stiffener; and
the shorting bar is uncovered by the stiffener.
